(19) United States
(12) Patent Application Publication
(10) Pub. No.: US 2004/0050560 A1
(43) Pub. Date: Mar. 18, 2004

(54) Tillage apparatus

(76) Inventors: Yves Riberon, Bron (FR); Jean-Claude Robert-Peillard, Communay (FR)

Correspondence Address: Oliff & Berridge, PO Box 19928, Alexandria, VA, 22320, US

(21) Appl. No.: 10/297,678

(22) PCT Filed: Jun. 25, 2001
(86) PCT No.: PCT/FR01/02008

(30) Foreign Application Priority Data
Jun. 26, 2000 (FR) 00/08183

(51) Int. Cl. A01B 33/00

(52) U.S. Cl. 172/45

(57) ABSTRACT

The invention concerns an apparatus comprising an arm (4) which, mounted on a support at one of its ends, comprises several elements (5, 6, 7) articulated on one another about horizontal pins (8, 9) and equipped, at its other end, with a tool-holder (15). At its free end, the arm is equipped with a rotary actuator (12) with rotation pin (12) transverse to the hinge pins (8, 9) of the elements (5, 6, 7) of the arm, and on the lower part of which is fixed a housing (15) containing a motor (16) designed to drive an output shaft (23) transverse to the rotary actuator axis and at the tip of which is mounted cantilevered a tool (33, 34). The invention is applicable to tillage on steep grounds or with marked irregular features, such as trenches.

The subject of the present invention is an apparatus for working the soil.

The apparatus concerned is intended in particular to work the soil in somewhat inaccessible regions such as trenches. This soil-working apparatus may be an apparatus which turns the soil over at the surface, or deeper down, so as to clean the surface that is to be worked, or to make it safe. This apparatus may also be used for neutralizing anti-personnel mines in regions to which access is difficult, such as trenches. Indeed, it is known practice for apparatuses to be used for detecting anti-personnel mines, these apparatuses working on relatively flat surfaces, detecting and exploding anti-personnel mines either by exerting pressure on or vibrating the ground, or by uncovering a layer of earth, for example using rotary implements. However, such apparatuses are not suited to working in sloping land or land with unevennesses.

The apparatus according to the invention comprises an arm mounted on a support at one of its ends and having several elements articulated to one another about horizontal axles. The support on which the arm is mounted may, for example, consist of a turret mounted to pivot about a vertical axis on the chassis of a vehicle. The free end of the arm is equipped with an implement holder.

The object of the invention is to provide an apparatus of this type which can work in sloping land or land exhibiting pronounced irregularities, such as in trenches.

To this end, in the apparatus to which it relates, of the aforementioned type, the free end of the arm is equipped with a rotary actuator the axis of rotation of which is transversal to the axles about which the elements of the arm are articulated and, on the lower part of which is fixed a unit containing a motor intended to drive an output shaft transversal to the axis of the rotary actuator and at the end of which an implement is mounted with overhang.

Advantageously, the output shaft at the end of which the implement is mounted is parallel to the ground.

The implement is therefore mounted with overhang at the end of the output shaft of the drive motor which is, for example, a hydraulic motor. As this implement is mounted to pivot about a horizontal axle, it will therefore work in a vertical plane. It is therefore possible to work in a very narrow region such as a trench by orientating the working plane in the direction of the trench or to work very close to an obstacle, such as a wall, by altering the position of the arm which is made up of several elements articulated to one another, and the angular position of the implement-carrying unit with respect to the end of the arm by virtue of the rotary actuator.

Advantageously, in this apparatus, the output shaft at the end of which the implement is mounted is equipped with means of displacement in translation along its axis. It is thus possible to widen the area of action of the implement by giving the output shaft a reciprocating movement. Thus, for example, if the width of the working region of the implement is 10 cm and the stroke of the ram is 30 cm, it will be possible, for the same position of the arm, to obtain a working of the land over a width of 40 cm.

According to one option, the means of displacing the output shaft in translation consist of a hydraulic ram.

According to one embodiment of the apparatus according to the invention, inside the unit mounted at the free end of the arm is pivotably mounted a bushing equipped at its periphery with a toothed annulus meshing with a pinion driven off the motor and inside which there is mounted, free to translate but locked in terms of rotation, a hollow shaft forming a cylinder for a piston fixed to the end of a rod integral with the unit.

According to one option in this case, the hollow shaft is rendered integral in terms of rotation with the bushing by a set of complementing splines formed in their contacting faces. Furthermore, advantageously, the ram supply circuit comprises ducts formed in the rod of the ram.

The implement mounted with overhang at the end of the output shaft of the motor may have various forms. It may, for example, be a hub to which are fixed the ends of chains, the other ends of which are equipped with bob weights, or a hub to which are fixed several radial arms the free ends of which are sharpened.

According to another embodiment, this implement comprises a disk or several parallel disks the center(s) of which is(are) fixed on the end of the shaft and the periphery(ies) of which comprise(s) teeth.

In another embodiment, the implement mounted with overhang at the end of the output shaft comprises a disk supporting, on a first angular sector, a portion of cylindrical surface, from which there extends at least one tooth able to penetrate the ground and, on a second angular sector, a number of rods able to move aside the soil displaced by the tooth.

As a preference, the orientation of the rods varies gradually from an orientation that is divergent with respect to rotation to an orientation of the rods parallel to the axis of rotation.

In addition, several teeth extend from the cylindrical portion, two of them situated near the front edge of the portion in the direction of rotation, the other teeth being situated near the rear edge.

In any event, the invention will be clearly understood with the aid of the description which follows, with reference to the schematic appended drawing which, by way of non limiting examples, depicts one embodiment of this apparatus and several forms of embodiment of implements:

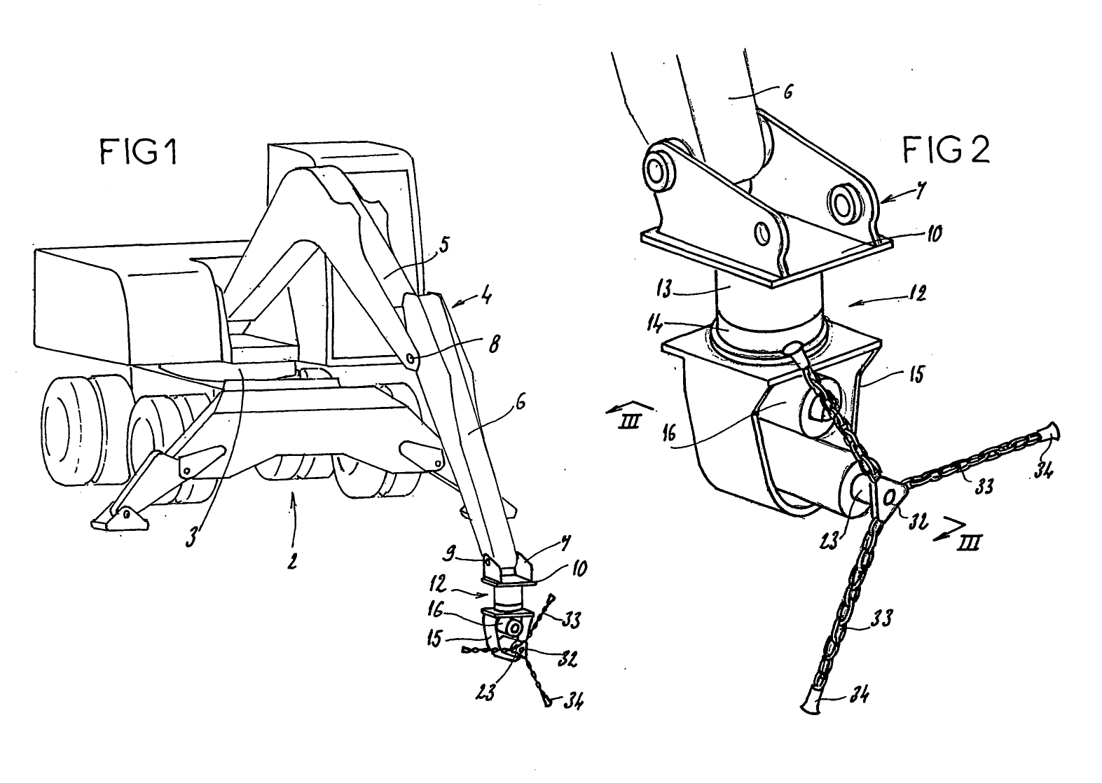

FIG. 1 is an overall perspective view depicting the entirety of the apparatus;

FIG. 2 is a perspective view on an enlarged scale of the part of the apparatus equipped with the implement;

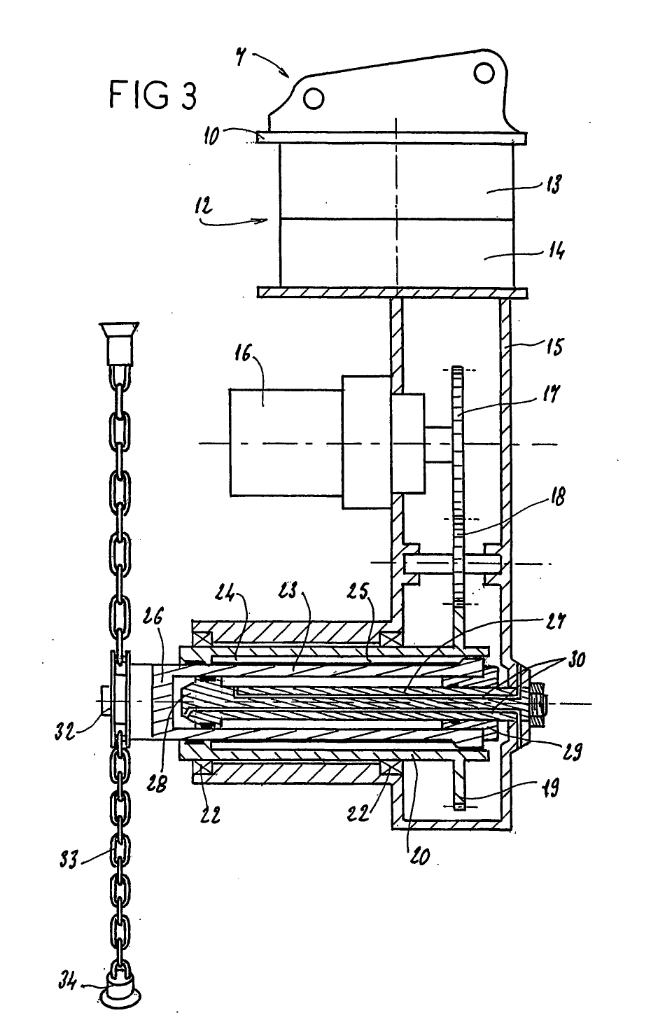

FIG. 3 is a view in longitudinal section and on an enlarged scale on III-III of FIG. 2;

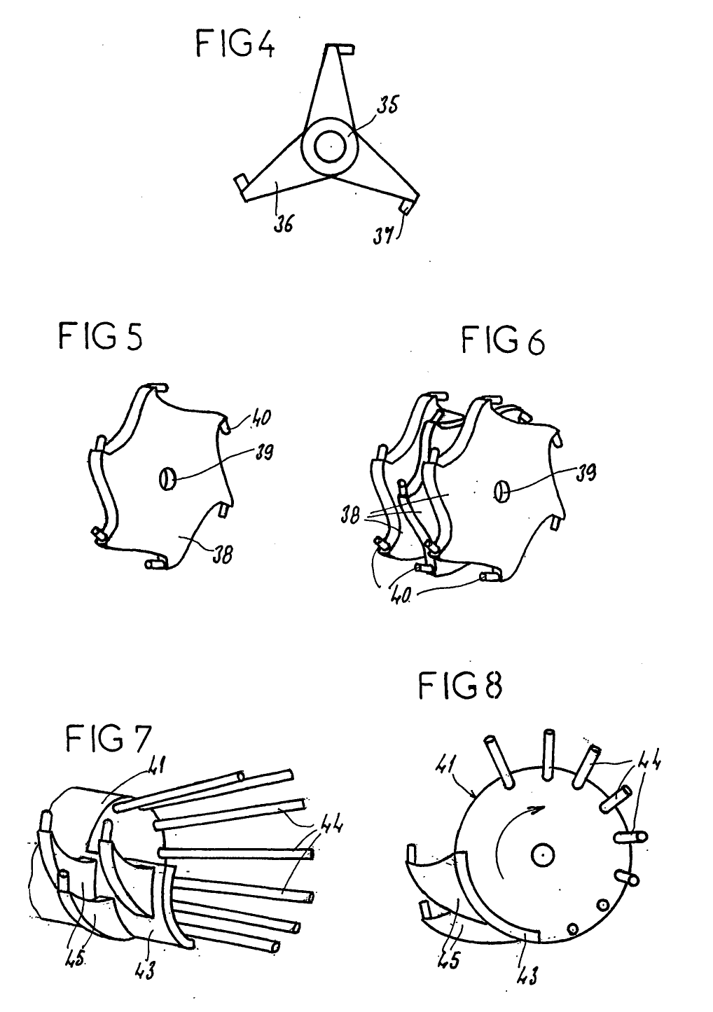

FIGS. 4 to 8 are five schematic views depicting four types of implement with which this apparatus may be equipped.

The apparatus depicted in the drawing comprises a motorized vehicle 2 on the chassis of which a turret 3 is mounted to pivot about a vertical axis. Mounted to pivot about a horizontal axis on this turret 3 is an arm 4 comprising three elements 5, 6, 7 articulated to one another about two horizontal axles 8 and 9. Angle sensors provide the position of the elements relative to one another and allow a mounting plate 10 belonging to the element 7 to be kept in a position parallel to the ground. Mounted on this mounting plate 10 is a rotary actuator 12 the upper part 13 of which is fixed to the mounting plate and the lower part 14 of which is mounted to pivot on the upper part 13. The part 14 is secured to a unit 15 acting as an implement holder.

Mounted in the unit 15 is a hydraulic motor 16 the output shaft of which is equipped with a pinion 17 meshing with a pinion 18 of parallel axis. This pinion 18 meshes, for its part, with an toothed annulus 19 secured to a bushing 20 mounted to pivot about a horizontal axis in the unit via bearings 22. This bushing 20, driven in rotation, is prevented from translation in the unit. Mounted inside the bushing 20 is a hollow shaft 23 comprising, on its outer face, male splines 24 collaborating with female splines 25 of the bushing 20 to prevent the shaft 23 from rotating with respect to the bushing 20 while at the same time allowing this shaft a translational movement with respect to the bushing. The shaft 23 protrudes beyond the unit and its free end has an end wall 26 allowing this shaft 23 to act as a cylinder. This cylinder is engaged on a fixed rod 27, the widened end 28 of which forms a piston. The cylinder is equipped, at its rear end, with an annular element 29 providing sealing around the rod 27. Formed in the rod 27 are ducts 30 for the circulation of a hydraulic fluid, supplying and emptying chambers delimited between the hollow shaft 33 on the one hand and the rod and the piston 28 on the other.

Depending on the way in which hydraulic fluid is supplied to these chambers, the shaft 23 can slide relative to the bushing 20 while being made to rotate by the latter.

The end 26 of the shaft 23 is equipped with implement securing means. In the embodiment depicted in FIGS. 1 to 3, this implement comprises a hub 32 for attachment to the shaft and from which there extend three chains 33 to the end of each of which a bob weight 34 is fixed. When the shaft 23 is rotated, the chains 33 will adopt a radial position and the bob weights will strike the ground, making a groove of some depth therein.

In the embodiment depicted in FIG. 4, the implement comprises a hub 35 from which there extend three radial arms 36 at the ends of each of which a sharpened part 37 is mounted.

In the embodiment depicted in FIG. 5, the implement has the overall shape of a disk 38, the center 39 of which serves for the attachment to the shaft and the periphery of which has several teeth 40 uniformly distributed.

FIG. 6 depicts an alternative form of embodiment of the implement of FIG. 5, this implement then consisting of three disks 38 arranged parallel to one another and secured in terms of rotation with the interposition of spacer pieces which have not been depicted in the drawing.

FIGS. 7 and 8 show a third embodiment of the implement, in which embodiment a disk 41 is extended axially on an angular sector by a cylinder portion 43 and on a second annular sector by a number of rods 44.

As is apparent from FIG. 8, the orientation of the rods 44 varies gradually in the direction of rotation of the implement from an orientation of the rods 44 that is divergent with respect to the axis of rotation to an orientation in which the rods 44 are parallel to this axis.

FIG. 7 shows that three teeth 45 offset from one another extend from the outer face of the cylinder portion 43.

From a practical point of view, the vehicle is first of all positioned so that the end of its arm 4 can reach the region in which the ground is to be worked. This region is reached by altering the articulation of the various elements 5, 6, 7 of the arm relative to one another and by rotating the unit with respect to the mounting plate 10 so that the implement can describe a working sequence that is predetermined and controlled by a computer or can describe a working sequence simply under the initiative of the operator. This working sequence may involve combined movements of displacing the arm and translating the implement-bearing shaft with respect to the unit in which it is mounted. The stroke and the frequency of displacement of the shaft can be controlled by a sequencer.

As is evident from the foregoing, the invention provides a great improvement to the known art by supplying an apparatus for working the soil that allows this work to be performed systematically, even in highly inaccessible regions.

When the vehicle is equipped with the implement depicted in FIGS. 7 and 8, when the implement rotates the teeth 45 enter the ground and, in particular, when the ground is hard, tear out clumps. These clumps then drop into the rods 44 which, on the one hand, have a sifting action and play a part in breaking these clumps up and, on the other hand, have an action of moving these clumps aside onto a region of the ground which has already been worked. The latter action makes it possible in particular for the implement not to pick back up clumps which have already passed through it.

As goes without saying, the invention is not restricted to the sole embodiment of this apparatus which is described hereinabove by way of example or to the sole embodiments of the implements which have been disclosed; on the contrary, it encompasses all alternative forms thereof. Thus, in particular, the ram for the reciprocating translational movement of the implement could comprise a cylinder or a rod depending on which way round it is mounted, receiving, at its end, a thrust roller bearing allowing the ram to be kept fixed in terms of rotation without thereby in any way departing from the scope of the invention.

1. An apparatus for working the soil, comprising an arm (4) which, mounted on a support at one of its ends, comprises several elements (5, 6, 7) articulated to one another about horizontal axles (8, 9) and is equipped, at its other end, with an implement bearer (15), characterized in that at this end the arm is equipped with a rotary actuator (12) the axis of rotation of which is transversal to the axles (8, 9) about which the elements (5, 6, 7) of the arm are articulated and, on the lower part of which is fixed a unit (15) containing a motor (16) intended to drive an output shaft (23) transversal to the axis of the rotary actuator and at the end of which an implement (33, 34) is mounted with overhang.

2. The apparatus as claimed in claim 1, characterized in that the output shaft (23) at the end of which the implement is mounted is parallel to the ground.

3. The apparatus as claimed in one of claims 1 and 2, characterized in that the output shaft (23) at the end of which the implement is mounted is equipped with means of displacement in translation along its axis.

4. The apparatus as claimed in claim 3, characterized in that the means of displacing the output shaft in translation consist of a hydraulic ram.

5. The apparatus as claimed in claim 4, characterized in that, inside the unit (15) mounted at the free end of the arm (4) is pivotably mounted a bushing (20) equipped at its periphery with a toothed annulus (19) meshing with a pinion (18) driven off the motor (16) and inside which there is mounted, free to translate but locked in terms of rotation, a hollow shaft (23) forming a cylinder for a piston (28) fixed to the end of a rod (27) integral with the unit.

6. The apparatus as claimed in claim 5, characterized in that the hollow shaft (23) is rendered integral in terms of translation with the bushing by a set of complementing splines (24, 25) formed in their contacting faces.

7. The apparatus as claimed in one of claims 5 and 6, characterized in that the supply circuit of the ram comprises ducts (30) formed in the rod (27) of the ram.

8. The apparatus as claimed in one of claims 1 to 7, characterized in that the implement mounted with overhang at the end of the output shaft comprises a hub (32) to which are fixed the ends of chains (33) the other ends of which are fitted with bob weights (34).

9. The apparatus as claimed in one of claims 1 to 7, characterized in that the implement mounted with overhang at the end of the output shaft comprises a hub (35) to which are fixed several radial arms (36) the free ends (37) of which are sharpened.

10. The apparatus as claimed in one of claims 1 to 7, characterized in that the implement mounted with overhang at the end of the output shaft comprises a disk (38) or several parallel disks, the center(s) (39) of which is(are) fixed on the end of the shaft and the periphery(ies) of which comprise(s) teeth (40).

11. The apparatus as claimed in any one of claims 1 to 7, characterized in that the implement mounted with overhang at the end of the output shaft comprises a disk (41) supporting, on a first anular sector, a portion of cylindrical surface (43), from which there extends at least one tooth (45) able to penetrate the ground and, on a second anular sector, a number of rods (44) able to move aside the soil displaced by the tooth (45).

12. The apparatus as claimed in claim 11, characterized in that the orientation of the rods (44) varies gradually from an orientation that is divergent with respect to rotation to an orientation of the rods parallel to the axis of rotation.

13. The apparatus as claimed in claim 11 or claim 12, characterized in that several teeth (45) extend from the cylindrical portion (43) two of them situated near the front edge of the portion in the direction of rotation, the other teeth being situated near the rear edge.
